(19) United States
(12) Patent Application Publication
(10) Pub. No.: US 2012/0081808 A1
(43) Pub. Date: Apr. 5, 2012

(54) BEAM GUIDING BELLOWS FOR LASER CUTTING MACHINE, AND METHOD OF MANUFACTURING BEAM GUIDING BELLOWS FOR LASER CUTTING MACHINE

(76) Inventors: Norio Nagai, Mie (JP); Yoshio Nishida, Mie (JP)

(21) Appl. No.: 13/376,174

(22) PCT Filed: Feb. 18, 2011
(86) PCT No.: PCT/JP2011/053544

§ 371 Date: Dec. 2, 2011

(30) Foreign Application Priority Data
Feb. 19, 2010 (JP) 2010-034292

(51) Int. Cl. G02B 7/22; B23P 19/04

(52) U.S. Cl. 359/871; 29/454

(57) ABSTRACT

Disclosed are a novel beam guiding bellows for laser cutting machine, and a method of manufacturing the beam guiding bellows for laser cutting machine, which no longer need a process of placing any special plates such as reflective plates, therefore enabling manufacturing in a shorter time at low costs. The beam guiding bellows is configured by a plurality of stacked sheet bodies integrally folded so as to alternately form hill sections and valley sections, and is thereby made freely expandable and retractable in the overall length as angles of the hill sections and valley sections vary, wherein the inner sheet body disposed innermostly is composed of a material capable of protecting the inner sheet body by absorbing or reflecting the laser light having been scattered or reversed, or having, formed on the inner surface thereof, a protective layer composed of a material capable of protecting the inner sheet body by absorbing or reflecting the laser light, and the inner sheet body has protruding flaps which are formed, automatically in the process of folding it together with the other sheet bodies to thereby form the hill sections and the valley sections alternately, so as to project further inwardly from the apexes of the valley sections.

### TECHNICAL FIELD

The present invention relates to a beam guiding bellows for laser cutting machine, which is disposed along an optical path of laser cutting machine, and a method of manufacturing the beam guiding bellows for laser cutting machine.

### BACKGROUND ART

Laser cutting machine has an optical path along which laser light emitted from a laser oscillator is guided to a condenser lens attached to a machining head, or, for the case where it has a reflective mirror disposed in the middle way between the oscillator and the machining head, it has an optical path from the oscillator to the reflective mirror, and an optical path from the reflective mirror to the condenser lens. Along these optical paths, a bellows is disposed in order to protect the condenser lens and the mirror from being damaged by aerial dusts, or to protect an operator from being irradiated by the laser light. The laser light emitted from the oscillator is, however, not always guided along a straight optical path, but is often diverted or scattered to thereby irradiate the inner surface of the bellows and damage the bellows. One possible reason is ascribable to dust which enters the bellows in the course of expansion and retraction thereof in association with movement of the machining head. The laser light may produce the scattered light by collision on dust which entered the bellows, or on dust adhered on the condenser lens or the reflective mirror, or may reverse the direction of propagation after being reflected on a work typically composed of a metal. The bellows, irradiated by the laser light thus scattered or reversed, is highly causative of burning even if it is made of a flame-retardant material, and such burning of the bellows may consequently result in considerable loss of productivity of the laser cutting machine.

For the purpose of preventing the bellows from being burnt or damaged-by the laser light, there has been proposed a beam guiding bellows for laser cutting machine, which has reflective plates composed of metal plates made of aluminum or copper, and attached to the inclined portions, between the hill sections and valley sections, of the inner surface of a main bellows component of the beam guiding bellows (see Patent Document 1). According to the beam guiding bellows of a laser cutting machine thus attached with the reflective plates, the risk of burning or damage of the main bellows component, due to the scattered or reversed laser light undesirably incident on the inner surface of the main bellows component, is avoidable since the main bellows component may be protected by the reflective plates.

### RELATED DOCUMENTS

### Patent Document

[Patent Document 1] Japanese Laid-Open Patent Publication No. 2003-71584

### DISCLOSURE OF THE INVENTION

### Problems to be Solved by the Invention

The beam guiding bellows for laser cutting machine disclosed in the above-described Patent Document 1 may successfully achieve an effect of the reflective plates, but is very time-consuming for the manufacturing enough to raise the cost, since the reflective plates have to be attached one by one typically by adhesion, on the inclined portions formed in the inner surface of the bellows.

The present invention was conceived after considering the above-described problems in the conventional beam guiding bellows for laser cutting machine, and the method of manufacturing the same. It is therefore an object of the present invention to provide a novel beam guiding bellows for laser cutting machine, and a method of manufacturing the same, which are capable of not only avoiding a risk of burning or damage of the bellows even if it should be incident on the inner surface thereof by the scattered or reversed laser light, but also no longer needing a process of placing any special plates such as reflective plates, therefore enabling manufacturing in a shorter time at low costs.

### Means for Solving the Problems

According to a first aspect of the present invention (invention described in Claim 1), aimed at solving the problems, there is provided a beam guiding bellows for laser cutting machine, which is disposed along an optical path of a laser cutting machine for irradiating laser light emitted from an oscillator. The beam guiding bellows is configured by a plurality of stacked sheet bodies, including an inner sheet body disposed innermostly, integrally folded so as to alternately form hill sections and valley sections, and is thereby made freely expandable and retractable in the overall length as angles of the hill sections and valley sections vary. The inner sheet body is composed of a material capable of protecting the inner sheet body by absorbing or reflecting the laser light having been scattered or reversed, or has, formed on the inner surface thereof, a protective layer composed of a material capable of protecting the inner sheet body by absorbing or reflecting the laser light. The inner sheet body has protruding flaps which are formed, automatically in the process of folding it together with the other sheet bodies to thereby form the hill sections and the valley sections alternately, so as to project further inwardly from the apexes of the valley sections.

According to the beam guiding bellows for laser cutting machine of the first aspect of the present invention (simply referred to as “beam guiding bellows”, hereinafter), since the inner sheet body is composed of material capable of protecting the inner sheet body by absorbing or reflecting the laser light having been scattered or reversed, or has, formed on the inner surface thereof, a protective layer composed of a material capable of protecting the inner layer by absorbing or reflecting the laser light, so that the beam guiding bellows may effectively be prevented from being burnt or damaged, even if the inner sheet body was irradiated by the laser light after being scattered on dust adhered on the condenser lens or the reflective mirror, or after being reversed by reflection on a work typically composed of a metal. Also since the beam guiding bellows has protruding flaps which are formed so as to project further inwardly from the apexes of the valley sections, so that the reversed laser light incident on one of the protruding flaps will no longer irradiate the inner sheet body and the protruding flaps which fall behind (closer to the oscillator than) the irradiated protruding flap. Accordingly, by virtue of the inwardly projected arrangement of the protruding flaps inside the beam guiding bellows, a risk of burning or other damages is more effectively avoidable.

Moreover, the protruding flaps possibly irradiated by the scattered laser light or the like may be formed (projected) automatically in the process of folding the inner sheet body together with the other sheet bodies to thereby form the hill sections and the valley sections alternately, so as to project further inwardly from the apexes of the valley sections, with no need of attaching any special plates such as reflective plates one by one on the inner surface of the main bellows component already shaped or before being shaped, such as done in the process of manufacturing the conventional beam guiding bellows, so that the bellows may be manufactured within a very short time at low costs. In other words, the beam guiding bellows may be finished at the end of manufacturing of the main bellows component which composes the conventional beam guiding bellows, without needing any succeeding process of, for example, attaching the plates such as the reflective plates. This not only contributes to reduce the number of components and weight as a consequence, but also largely shorten the time of manufacturing.

The sheet body which composes the beam guiding bellows may be composed of two sheet bodies including an outer sheet body which composes the outer surface (outermost cloth) of the beam guiding bellows and the inner sheet body which composes the inner surface; or may have one or two additional sheet bodies between the outer sheet body and the inner sheet body. Each of the plurality of sheet bodies, but excluding the outermost cloth of the beam guiding bellows, is not always necessarily a continuous sheet body (single sheet body) per a single beam guiding bellows. For example, the inner sheet body composing the first aspect of the invention may be divided into a plurality of parts. The hill sections in the context of the present invention refer to the outwardly protruding flaps of the beam guiding bellows, and the valley sections refer to the inwardly protruding flaps of the beam guiding bellows. The inner sheet body may be good enough if it is composed of a material capable of protecting the inner sheet body by absorbing or reflecting the laser light having been scattered or reversed, or having, formed on the inner surface thereof, a protective layer composed of a material capable of protecting the inner sheet body by absorbing or reflecting the laser light having been scattered. The material capable of protecting the inner sheet body by absorbing or reflecting the scattered or reversed laser light may be exemplified by those made of anodized aluminum. The material may be used in the form of sheet obtained by rolling a single species thereof (aluminum foil, for example), or in the form of protective layer formed by coating or vacuum evaporation on a sheet-like material. The protruding flaps formed on the inner sheet body are preferably arranged so as to inwardly project from the valley sections located on the both lateral sides, and on the top and bottom sides, for the case where the beam guiding bellows is formed to have an overall geometry of nearly rectangular parallelepiped (cylinder having a square form in the front view). Even in this case, the protruding flaps are not always necessarily formed so as to project out from all valley sections aligned on both lateral sides and on the top and bottom sides, while leaving a part of valley sections without protruding flaps. For example, as described later, the protruding flaps may be formed on every other valley sections aligned in the direction of expansion and retraction of the bellows.

A second aspect of the present invention (invention described in Claim 2) is characterized in that, in the above-described first aspect of the invention, the hill sections and the valley sections are composed of vertical hill sections and vertical valley sections formed on both lateral sides, and transverse hill sections and transverse valley sections formed on the top and bottom sides, and every one of, or every other one of, the vertical valley sections and the transverse valley sections have the protruding flaps formed thereon.

The vertical hill sections and the vertical valley sections formed on both lateral sides may more specifically be represented by the individual vertical hill sections formed on the left side, the individual vertical valley sections formed between every adjacent vertical hill sections formed on the left side, the individual vertical hill sections formed on the right side, and the individual vertical valley sections formed between every adjacent vertical hill sections formed on the right side. On the other hand, the transverse hill sections and the transverse valley sections formed on the top and bottom sides may alternatively be represented by the individual transverse hill sections formed on the top side, the individual transverse valley sections formed between every adjacent transverse hill sections formed on the top side, the individual transverse hill sections formed on the bottom side, and the individual transverse valley sections formed between every adjacent transverse hill sections formed on the bottom side. In the second aspect of the present invention, every one of, or every other one of, the vertical valley sections and the transverse valley sections have the protruding flaps formed thereon.

Also according to the second aspect of the present invention, similarly to the first aspect of the invention, not only the main bellows component may successfully be protected and prevented from being burnt or damaged even if the scattered or reversed laser light is incident on the inner surface of the main bellows component, but also the process of arranging the reflective plates will be no more necessary, enabling manufacturing within a short time at low costs.

According to a third aspect of the present invention (invention described in Claim 3) is characterized in that, in the above-described first or second aspect of the invention, the inner sheet body has straight slits formed in portions corresponded to the apexes of the hill sections, or apexes of the vertical hill sections and the transverse hill sections. The straight slits are shorter than the overall length of the hill sections, or the overall length of the vertical hill sections and the transverse hill sections.

The hill sections herein represent the hill sections which configure the first aspect of the present invention (invention described in Claim 1), and the vertical hill sections and the transverse hill sections represent those configuring the second aspect of the present invention (invention described in Claim 2). In the third aspect of the present invention, the inner sheet body has the straight slits, which are formed in portions corresponded to the apexes of the hill sections, or apexes of the vertical hill sections and the transverse hill sections, and are shorter than the overall length of the hill sections, or the overall length of the vertical hill sections and the transverse hill sections. Each straight slit may be formed typically by cutting the inner sheet body using a cutting edge so as to have no width, or to have a predetermined width. The apexes of the hill sections, or the apexes of the vertical hill sections and the transverse hill sections, are portions where the folding of the inner sheet body repetitively occurs, as the beam guiding bellows expands and retracts.

According to the thus-configured third aspect of the present invention, since the straight slits having shorter length than the overall length of the hill sections, or the overall length of the vertical hill sections and the transverse hill sections, are formed in the portions corresponded to the apexes of the hill sections, or apexes of the vertical hill sections and the transverse hill sections, so that the configuration successfully avoids the risk of burning or damage of the beam guiding bellows, due to the laser light possibly scattered by dust which floats inside the bellows, after released from the inner sheet body as a result fatigue thereof or partial rupture or separation thereof, under repetitive folding in the process of expansion and retraction. The third aspect of the present invention is particularly effective in avoiding the risk of burning or damage of the beam guiding bellows, for the case where the inner sheet body is composed of a simple species of metal such as aluminum foil, since this sort of inner sheet body is causative of heavier (metal) fatigue under repetitive folding in the process of expansion and retraction, so that the dust which floats inside the beam guiding bellows will more heavily scatter the laser light incident thereon.

According to a fourth aspect of the present invention (invention described in Claim 4) is characterized in that, in the above-described second aspect of the invention, the individual vertical hill sections formed on the left side and the individual transverse valley sections formed on the top side are respectively joined at one set of left top corners, the individual vertical valley sections formed on the left side and the individual transverse hill sections formed on the top side are respectively joint at the other set of left top corners, the individual vertical hill sections formed on the right side and the individual transverse valley sections formed on the top side are respectively joined at one set of right top corners, the individual vertical valley sections formed on the right side and the individual transverse hill sections formed on the top side are respectively joined at the other set of right top corners, the individual vertical hill sections formed on the left side and the individual transverse valley sections formed on the bottom side are respectively joined at one set of left bottom corners, the individual vertical valley sections formed on the left side and the individual transverse hill sections formed on the bottom side are respectively joined at the other set of left bottom corners, the individual vertical hill sections formed on the right side and the individual transverse valley sections formed on the bottom side are respectively joined at one set of right bottom corners, and the individual vertical valley sections formed on the right side and the individual transverse hill sections formed on the bottom side are respectively joined at the other set of right bottom corners. The inner sheet body has first to fourth reinforcing sheet bodies, and each of which has the longitudinal direction thereof aligned in the direction of expansion and retraction, attached to the inner surface thereof. The first reinforcing sheet body covers the one and the other sets of left top corners, the second reinforcing sheet body covers the one and the other sets of right top corners, the third reinforcing sheet body covers the one and the other sets of left bottom corners, and the fourth reinforcing sheet body covers the one and the other sets of right bottom corners.

According to the fourth aspect of the present invention, since the above-described corner portions are covered respectively with the first, second, third and fourth reinforcing sheet bodies, so that the configuration successfully avoids the risk of burning or damage of the beam guiding bellows, due to the laser light possibly scattered by dust which floats inside the bellows, after released from the inner sheet body as a result fatigue thereof or partial rupture or separation thereof, under repetitive folding in the process of expansion and retraction.

According to a fifth aspect of the present invention (invention described in Claim 5) is characterized in that, in the above-described fourth aspect of the invention, the inner sheet body has U-shaped slits preliminarily formed therein before being folded to form the valley sections. The outer contour of each protruding flap corresponds to the geometry of the U-shaped slit, and each of the first to fourth reinforcing sheet bodies has a width ranging from the end of the straight slit to the end of the U-shaped slit.

In the beam guiding bellows for laser cutting machine according to the fifth aspect of the present invention, a portion of the inner sheet body, where the hill sections and the valley sections are formed by folding, and not covered by the first to fourth reinforcing sheet bodies, is a portion where the straight slits and the U-shaped slits are formed. According to the fifth aspect of the present invention, the configuration more successfully avoids the risk of burning or damage of the beam guiding bellows, due to the laser light possibly scattered by dust which floats inside the bellows, after released from the inner sheet body as a result fatigue thereof or partial rupture or separation thereof, under repetitive folding in the process of expansion and retraction.

According to a sixth aspect of the present invention (invention described in Claim 6), there is provided a method of manufacturing a beam guiding bellows for laser cutting machine, which include a step of producing a bellows-making stacked sheet body by stacking an outer sheet body and an intermediate sheet body and the inner sheet body so as to integrate them; and a step of folding the bellows-making stacked sheet body so as to alternately form hill sections and valley sections. The inner sheet body has formed therein U-shaped slits which are configured to automatically form, when folded to form valley sections therealong, protruding flaps so as to project them out from the apexes of the valley sections.

According to a seventh aspect of the present invention (invention described in Claim 7) is characterized in that, in the above-described sixth aspect of the invention, the inner sheet body has formed therein straight slits arranged in the longitudinal direction of the U-shaped slits, while keeping a predetermined distance in between, and the bellows-making stacked sheet body is folded so as to form the valley sections along the U-shaped slits and to form the hill sections along the straight slits.

According to the method of manufacturing a beam guiding bellows for laser cutting machine described in the sixth and seventh aspects of the present invention, the beam guiding bellows for laser cutting machine described in the first to fifth aspects of the present invention may be manufactured.

### EFFECT OF THE INVENTION

In the beam guiding bellows according to the first aspect of the present invention (invention described in Claim 1), since the inner sheet body is composed of a material capable of protecting the inner sheet body by absorbing or reflecting the laser light having been scattered or reversed, or has, formed on the inner surface thereof, a protective layer composed of a material capable of protecting the inner layer by absorbing or reflecting the laser light having been scattered, so that the beam guiding bellows may effectively be prevented from being burnt or damaged, even if the inner sheet body was irradiated by the laser light after being scattered on dust adhered on the condenser lens or the reflective mirror, or after being reversed by reflection on a work typically composed of a metal. Also since the beam guiding bellows has protruding flaps which are formed so as to project further inwardly from the apexes of the valley sections, so that the reversed laser light incident on any of the protruding flaps will no longer irradiate the inner sheet body and the protruding flaps which fall behind (closer to the oscillator than) the irradiated protruding flap. Accordingly, by virtue of the inwardly projected arrangement of the protruding flaps inside the beam guiding bellows, a risk of burning or other damages is more effectively avoidable.

Moreover, the protruding flaps possibly irradiated by the scattered or reversed laser light may be formed (projected) automatically in the process of folding the inner sheet body together with the other sheet bodies to thereby form the hill sections and the valley sections alternately, so as to project further inwardly from the apexes of the valley sections, with no need of attaching any special plates such as reflective plates one by one on the inner surface of the main bellows component already shaped or before being shaped, such as done in the process of manufacturing, the conventional beam guiding bellows. The bellows may therefore be manufactured within a very short time at low costs. In other words, the beam guiding bellows may be finished at the end of manufacturing of the main bellows component which composes the conventional beam guiding bellows, without needing any succeeding process of, for example, attaching the plates such as the reflective plates. This not only contributes to reduce the number of components and weight as a consequence, but also largely shorten the time of manufacturing.

In the beam guiding bellows according to the second aspect of the present invention (invention described in Claim 2), similarly to the first aspect of the invention described in the above, not only the main bellows component may successfully be protected and prevented from being burnt or damaged even if the scattered or reversed laser light is incident on the inner surface thereof, but also the process of arranging the reflective plates will be no more necessary, allowing manufacturing within a short time at low costs.

In the beam guiding bellows according to the third aspect of the present invention (invention described in Claim 3), since the straight slits having shorter length than the overall length of the hill sections, or the overall length of the vertical hill sections and the transverse hill sections, are formed in the portions corresponded to the apexes of the hill sections, or apexes of the vertical hill sections and the transverse hill sections, so that the configuration successfully avoids the risk of burning or damage of the beam guiding bellows, due to the laser light possibly scattered by dust which floats inside the bellows, after released from the inner sheet body as a result fatigue thereof or partial rupture or separation thereof, under repetitive folding in the process of expansion and retraction. The third aspect of the present invention is particularly effective in avoiding the risk of burning or damage of the beam guiding bellows, for the case where the inner sheet body is composed of a simple species of metal such as aluminum foil, since this sort of inner sheet body is causative of heavier (metal) fatigue under repetitive folding in the process of expansion and retraction, so that the dust which floats inside the beam guiding bellows will more heavily scatter the laser light incident thereon.

In the beam guiding bellows according to the fourth aspect of the present invention (invention described in Claim 4), since the above-described corner portions are covered respectively with the first, second, third and fourth reinforcing sheet bodies, so that the configuration successfully avoids the risk of burning or damage of the beam guiding bellows, due to the laser light possibly scattered by dust which floats inside the bellows, after released from the-inner-sheet body as a result fatigue thereof or partial rupture or separation thereof, under repetitive folding in the process of expansion and retraction.

In the beam guiding bellows according to the fifth aspect of the present invention (invention described in Claim 5), a portion of the inner sheet body, where the hill sections and the valley sections are formed by folding, and not covered by the first to fourth reinforcing sheet bodies, is a portion where the straight slits and the U-shaped slits are formed. According to the fifth aspect of the present invention, the configuration more successfully avoids the risk of burning or damage of the beam guiding bellows, due to the laser light possibly scattered by dust which floats inside the bellows, after released from the inner sheet body as a result fatigue thereof or partial rupture or separation thereof, under repetitive folding in the process of expansion and retraction.

According to the method of manufacturing a beam guiding bellows. for laser cutting machine described in the sixth and seventh aspects of the present invention (inventions described in Claims 6 and 7), the beam guiding bellows for laser cutting machine described in the first to fifth aspects of the present invention may be manufactured.

### BRIEF DESCRIPTION OF THE DRAWINGS

FIG. 1 is a perspective view, partially broken away, illustrating a beam guiding bellows for laser cutting machine according to an embodiment of the present invention;

FIG. 2 is a perspective view, partially broken away, illustrating the beam guiding bellows for laser cutting machine illustrated in FIG. 1;

FIG. 3 is a front elevation illustrating the beam guiding bellows for laser cutting machine illustrated in FIG. 1;

FIG. 4 is a cross-sectional view of the beam guiding bellows for laser cutting machine illustrated in FIG. 3, taken along the line A-A;

FIG. 5 is a cross-sectional view of the beam guiding bellows for laser cutting machine illustrated in FIG. 3, taken along the line B-B;

FIG. 6 is a left side elevation illustrating the beam guiding bellows for laser cutting machine illustrated in FIG. 3;

FIG. 7 is a right side elevation illustrating the beam guiding bellows for laser cutting machine illustrated in FIG. 3;

FIG. 8 is perspective view, partially broken away, illustrating the beam guiding bellows for laser cutting machine illustrated in FIG. 1; and

FIG. 9 is a plan view, partially broken away, illustrating a bellows-making stacked sheet body.

### EXPLANATION OF THE MARKS

1 beam guiding bellows for laser cutting machine
2 bellows-making stacked sheet body
2a left vertical hill sections
2b left vertical valley sections
2c right vertical hill sections
2d right vertical valley sections
2e upper transverse hill sections
2f upper transverse valley sections
2g lower transverse hill sections
2h lower transverse valley sections
6 fourth sheet body
6a left protruding flap
6b right protruding flap
6c upper protruding flap
6d lower protruding flap
6e (U-shaped) left slit
6f (U-shaped) right slit
6g (U-shaped) upper slit
6h (U-shaped) lower slit
6s left straight slit
6t lower straight slit
6u right straight slit
6v upper straight slit
8 first reinforcing sheet body
9 second reinforcing sheet body
10 third reinforcing sheet body

### DETAILED DESCRIPTION

The beam guiding bellows for laser cutting machine, according to best embodiments for carrying out the present invention will be detailed below, referring to the attached drawings.

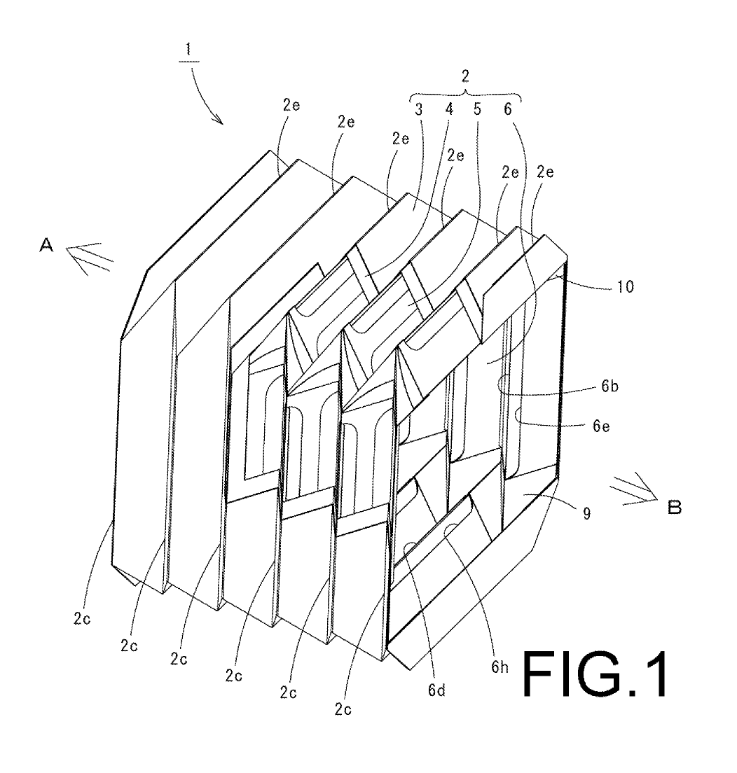

A beam guiding bellows for laser cutting machine according to this embodiment (simply referred to as beam guiding bellows, hereinafter) 1 is configured, as illustrated in FIG. 1, by folding a bellows-making stacked sheet body 2 into a square cylindrical form. The beam guiding bellows 1 is disposed so as to cover an optical path of laser light emitted from an oscillator owned by an unillustrated laser cutting machine. In the individual drawings, the oscillator is disposed in the direction indicated by arrow A, and the optical path extends therefrom in the direction indicated by arrow B, towards a reflective mirror or a condenser lens. The description below will be given, assuming the portions located closer to the direction A as the front side, and those located closer to the direction B as the rear side.

The bellows-making stacked sheet body 2 is, as illustrated in FIG. 1, composed of a first sheet body 3 which composes the outermost cloth of the beam guiding bellows 1, a second sheet body 4 which is disposed as an interlining behind the first sheet body 3, a third sheet body 5 which binds the second sheet body 4 and a fourth sheet body 6 which will be described in the next to each other, the fourth sheet body 6 attached to the third sheet body 5, and first to fourth reinforcing sheet bodies (reference numerals not given) which will be explained later in relation to a method of manufacturing of the beam guiding bellows. Note that FIG. 1 shows the appearance of the beam guiding bellows 1, while partially braking the second sheet body 4, the third sheet body 5 and the fourth sheet body 6, for better understanding of the configuration of the bellows-making stacked sheet body 2. The first sheet body 3 is the outer sheet body which configures the present invention, or the outermost cloth of the beam guiding bellows 1, and is configured in this embodiment by a sheet composed of synthetic leather. The first sheet body 3 has an unillustrated adhesive (or pressure-sensitive adhesive) coated on the inner surface (back surface) thereof. The second sheet body 4 is the intermediate sheet body which configures the present invention, or an interlining which ensures shape retention of the beam guiding bellows 1, and is composed of a material slightly more rigid than the first sheet body 3. The second sheet body 4 is specifically composed of polyethylene terephthalate (PET) or the like, and has straight slits formed periodically at the portions where the hill sections and the valley sections will be formed when the bellows-making stacked sheet body 2 is folded, as described later. In the beam guiding bellows 1 of this embodiment, the second sheet body 4 is divided into four parts. A specific configuration of the second sheet body 4 will be described later in relation to the method of manufacturing the beam guiding bellows. The fourth sheet body 6 is the inner sheet body which configures the present invention, specifically configured by a film-like base typically composed of polyethylene terephthalate (PET) and an alumite layer (protective layer) formed on the inner surface or the outer surface thereof, and has two types of slits (U-shaped slits and straight slits) formed therein, as described later. In the beam guiding bellows 1 of this embodiment, the fourth sheet body 6 is divided into four parts. The third sheet body 5 is used for bonding the second sheet body 4 and the fourth sheet body 6, and has an adhesive (or pressure-sensitive adhesive) coated on both surfaces. In the beam guiding bellows 1 of this embodiment, also the third sheet body 5 is divided into four parts, corresponding to the number of division of the fourth sheet body 6. Also the configuration of the third sheet body 5 and the fourth sheet body 6 will be detailed later. Accordingly, the first sheet body 3 and the second sheet body 4 are bonded via an adhesive (or pressure-sensitive adhesive) coated on the inner surface of the first sheet body 3, and the second sheet body 4 and the fourth sheet body 6 are bonded via the third sheet body 5. The bellows-making stacked sheet body 2 is thus configured by integrally stacking the first to fourth sheet bodies 3 to 6. The first to fourth reinforcing sheet bodies will be explained later.

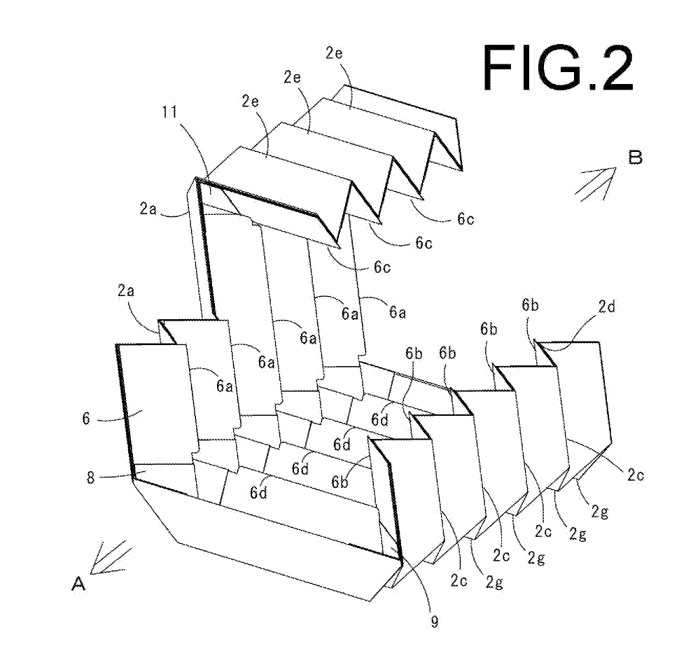

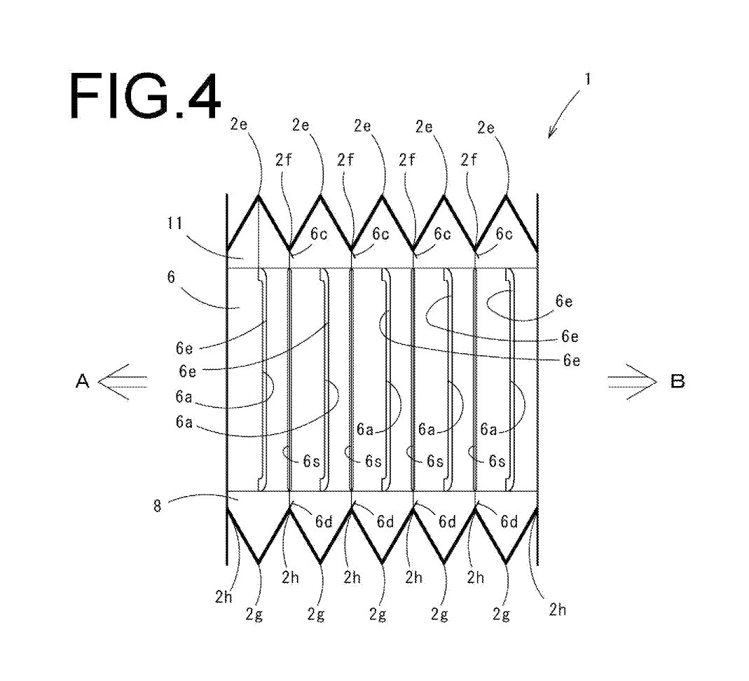

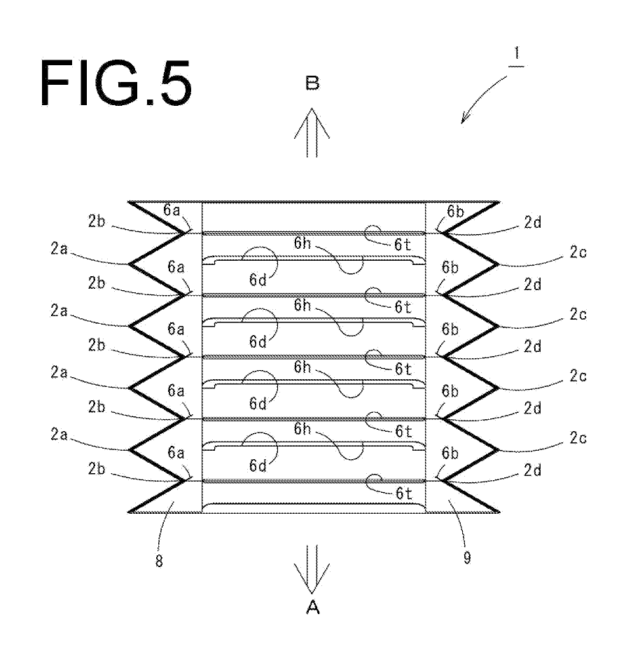

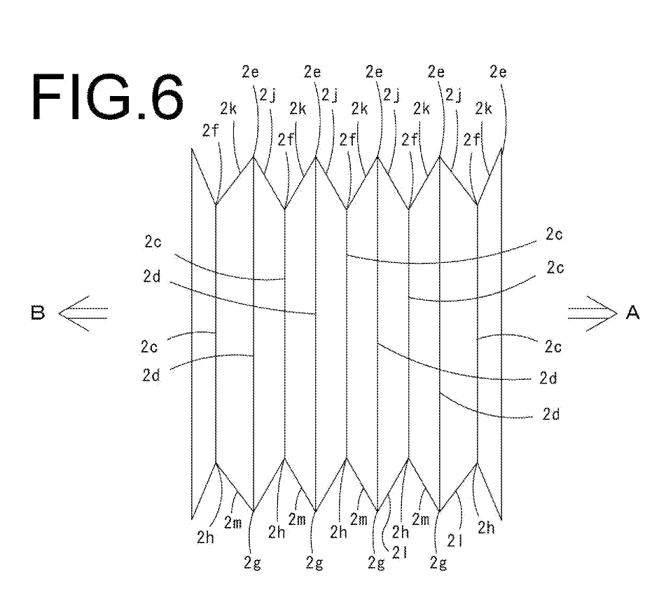

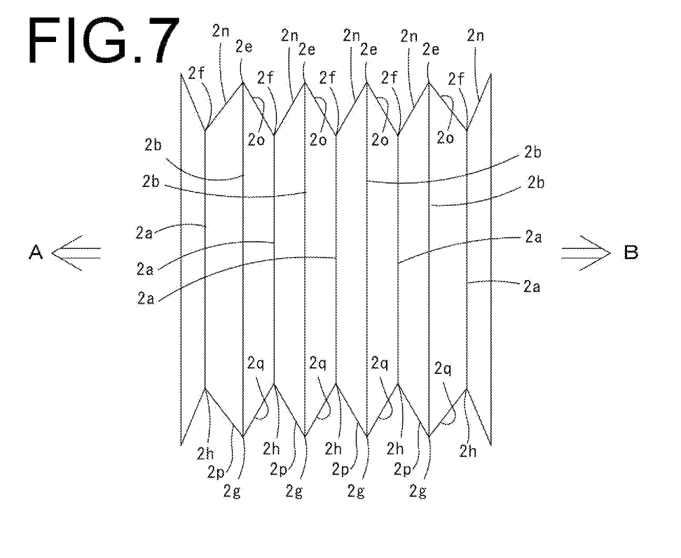

The bellows-making stacked sheet body 2, having the first to fourth sheet bodies 3 to 6 (and the first to fourth reinforcing sheet bodies) integrated therein, is folded so as to alternately form hill sections and valley sections (reference numerals not given), as illustrated in FIG. 1. The hill sections and valley sections will further be detailed. As illustrated in FIG. 2, FIG, 3, FIG. 4 or FIG. 5, in the left portion of the beam guiding bellows 1, there are formed left vertical hill sections 2a with the longitudinal direction thereof vertically aligned, and left vertical valley sections 2b formed alternately in between, whereas in the right portion of the beam guiding bellows 1, there are formed right vertical hill sections 2c with the longitudinal direction thereof vertically aligned, and right vertical valley sections. 2d formed alternately in between (see FIG. 5). In the top portion of the beam guiding bellows 1, there are formed upper transverse hill sections 2e with the longitudinal direction laterally aligned, and upper transverse valley sections 2f formed alternately in between, whereas in the bottom portion of the beam guiding bellows 1, there are formed lower transverse hill sections 2g with the longitudinal direction thereof laterally aligned, and lower transverse valley sections 2h formed alternately in between (see FIG. 4). The individual top ends of the left vertical hill sections 2a are joined, as illustrated in FIG. 6, with the individual upper transverse valley sections 2f at a corner portion (the one set of left top corners composing the present invention: a reference numeral not given), whereas the individual bottom ends are joined with the individual lower transverse valley sections 2h at a corner portion (the one set of left bottom corners composing the present invention: a reference numeral not given). On the other hand, the individual top ends of the left vertical valley sections 2b are joined with the individual upper transverse hill sections 2e at a corner portion (the other set of left top corners composing the present invention: a reference numeral not given), whereas the individual bottom ends are joined with the individual lower transverse hill sections 2g at a corner portion(the other set of left bottom corners composing the present invention: a reference numeral not given). Similarly, the individual top ends of the right vertical hill sections 2c are joined, as illustrated in FIG. 7, with the individual upper transverse valley sections 2f at a corner portion (the one set of right top corners composing the present invention: a reference numeral not given), whereas the individual bottom ends are joined with the individual lower transverse valley sections 2h at a corner portion (the one set of right bottom corners composing the present invention: a reference numeral not given). The individual top ends of the right vertical valley sections 2d are joined with the individual upper transverse hill sections 2e at a corner portion (the other set of right top corners composing the present invention: a reference numeral not given), and the individual bottom ends are joined with the individual lower transverse hill sections 2g at a corner portion (the other set of right bottom corners composing the present invention: a reference numeral not given).

The left end of every upper transverse hill section 2e and the left end of every upper transverse valley section 2f located ahead (in the direction indicated by arrow A) of the upper transverse hill section 2e are connected by one set of left upper slopes 2j as illustrated in FIG. 6, whereas the left end of every upper transverse hill section 2e and the left end of every upper transverse valley section 2f located behind (in the direction indicated by arrow B) the upper transverse hill section 2e are connected by the other set of left upper slopes 2k. The left end of every lower transverse hill section 2g and the left end of every lower transverse valley sections 2h located ahead (in the direction indicated by arrow A) of the lower transverse hill section 2g are connected by one set of left lower slopes 2l, whereas the left end of every lower transverse hill section 2g and the left end of every lower transverse valley section 2h located behind (in the direction indicated by arrow B) the lower transverse hill section 2g are connected by the other set of left lower slopes 2m. The right end of every upper transverse hill section 2e and the right end of every upper transverse valley section 2f located ahead (in the direction indicated by arrow A) of the upper transverse hill section 2e are connected, as illustrated in FIG. 7, by one set of right upper slopes 2n, whereas the right end of every upper transverse hill section 2e and the right end of every upper transverse valley section 2f located behind (in the direction indicated by arrow B) the upper transverse hill section. 2e are connected by the other set of right upper slopes 2o. The right end of every lower transverse hill section 2g and the right end of every lower transverse valley section 2h located ahead (in the direction indicated by arrow A) of the lower transverse hill section 2g are connected by one set of right lower slopes 2p, whereas the left end of every lower transverse hill section 2g and the right end of every lower transverse valley section 2h located behind (in the direction indicated by arrow B) the lower transverse hill sections 2g are connected by the other set of right lower slopes 2q. Accordingly, the beam guiding bellows 1 of this embodiment may expand or retract when the left vertical hill sections 2a, the left vertical valley sections 2b, the right vertical hill sections 2c, the right vertical valley sections 2d, the upper transverse hill sections 2e, the upper transverse valley sections 2f, the lower transverse hill sections 2g, the lower transverse valley sections 2h, one set of left upper slopes 2j, the other set of left upper slopes 2k, one set of left lower slopes 2l, the other set of left lower slopes 2m, one set of right upper slopes 2n, the other sets of right upper slopes 2o, one set of right lower slopes 2p, and the other set of right lower slopes 2q vary.

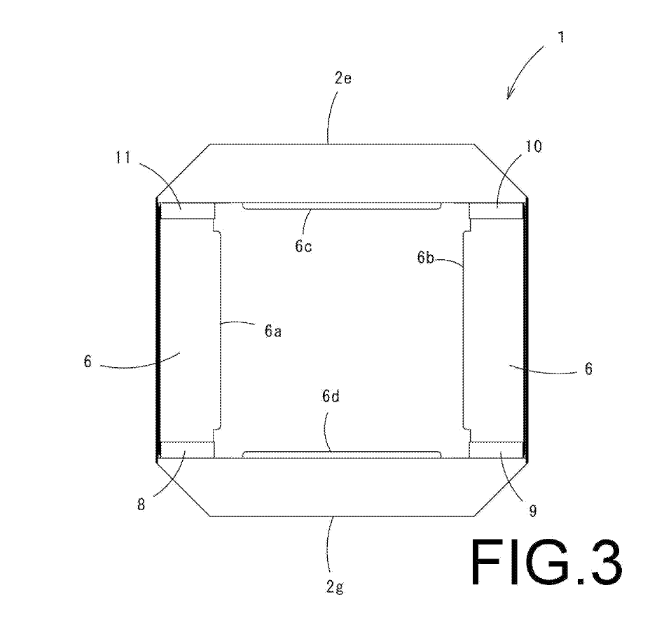

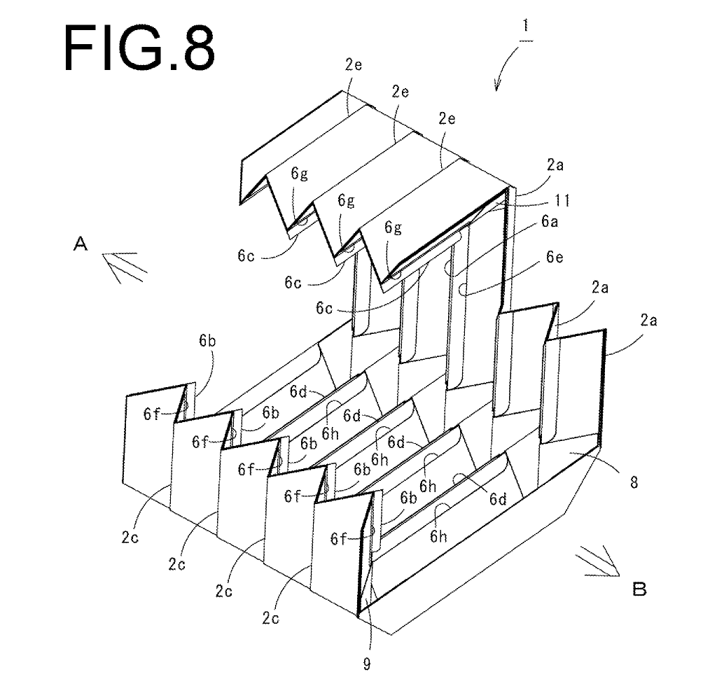

Inside the beam guiding bellows 1, the protruding flaps configuring the present invention are formed. As illustrated in FIG. 1, FIG. 2 or FIG. 3, the protruding flaps are specifically configured by a plurality of left protruding flaps 6a, a plurality of right protruding flaps 6b, a plurality of upper protruding flaps 6c, and a plurality of lower protruding flaps 6d. Each of the left protruding flaps 6a, the right protruding flaps 6b, the upper protruding flaps 6c and the lower protruding flaps 6d is a part of the fourth sheet body 6 as the inner sheet body which configures the present invention. Each left protruding flap 6a protrudes out from an inner portion (apex) of each left vertical valley section 2b inside the beam guiding bellows 1, and has a length shorter than the overall length of the left vertical valley section 2b as illustrated in FIG. 3 or FIG. 4. Each right protruding flap 6b protrudes out from an inner portion (apex) of each left vertical valley section 2d inside the beam guiding bellows 1, and has a length shorter than the overall length of the left vertical valley section 2d. Each upper protruding flap 6c protrudes out from an inner portion (apex) of each upper transverse valley section 2f inside the beam guiding bellows 1, and has a length shorter than the overall length of the upper transverse valley section 2f. Each lower protruding flap 6d protrudes out from an inner portion (apex) of each lower transverse valley section 2h inside the beam guiding bellows 1, and has a length shorter than the overall length of the lower transverse valley section 2h. In the fourth sheet body 6, and in the neighboring portions behind the left protruding flaps 6a (on the rear side of the beam guiding bellows 1, or, in the direction indicated by arrow B), there are formed left slits 6e which have a U-shaped geometry corresponding to the outer contour of the left protruding flaps 6a (see FIG. 4). In the fourth sheet body 6, and in the neighboring portions behind the right protruding flaps 6b (on the rear side of the beam guiding bellows 1), there are formed left slit 6f which have a nearly U-shaped geometry corresponding to the outer contour of the left protruding flaps 6b (see FIG. 8). In the fourth sheet body 6, and in the neighboring portions behind the right protruding flaps 6c (on the rear side of the beam guiding bellows 1), there are formed left slit 6g which have a nearly U-shaped geometry corresponding to the outer contour of the left protruding flaps 6c (see FIG. 8). In the fourth sheet body 6, and in the neighboring portions behind the right protruding flaps 6d (on the rear side of the beam guiding bellows 1), there are formed left slit 6h which have a nearly U-shaped geometry corresponding to the outer contour of the left protruding flaps 6d (see FIG. 5, FIG. 1 or FIG. 8).

In the fourth sheet body .6 (the inner sheet body composing the present invention), left straight slits are formed in the portions corresponded to the individual left vertical hill sections 2a, right straight slits are formed in the portions corresponded to the individual right vertical hill sections 2c, upper straight slits are formed in the portions corresponded to the individual upper transverse hill sections 2e, and lower straight slits are formed in the portions corresponded to the individual lower transverse hill sections 2g. The left straight slits, the right straight slits, the upper straight slits and the lower straight slits will be explained below in relation to a method of manufacturing the beam guiding bellows 1.

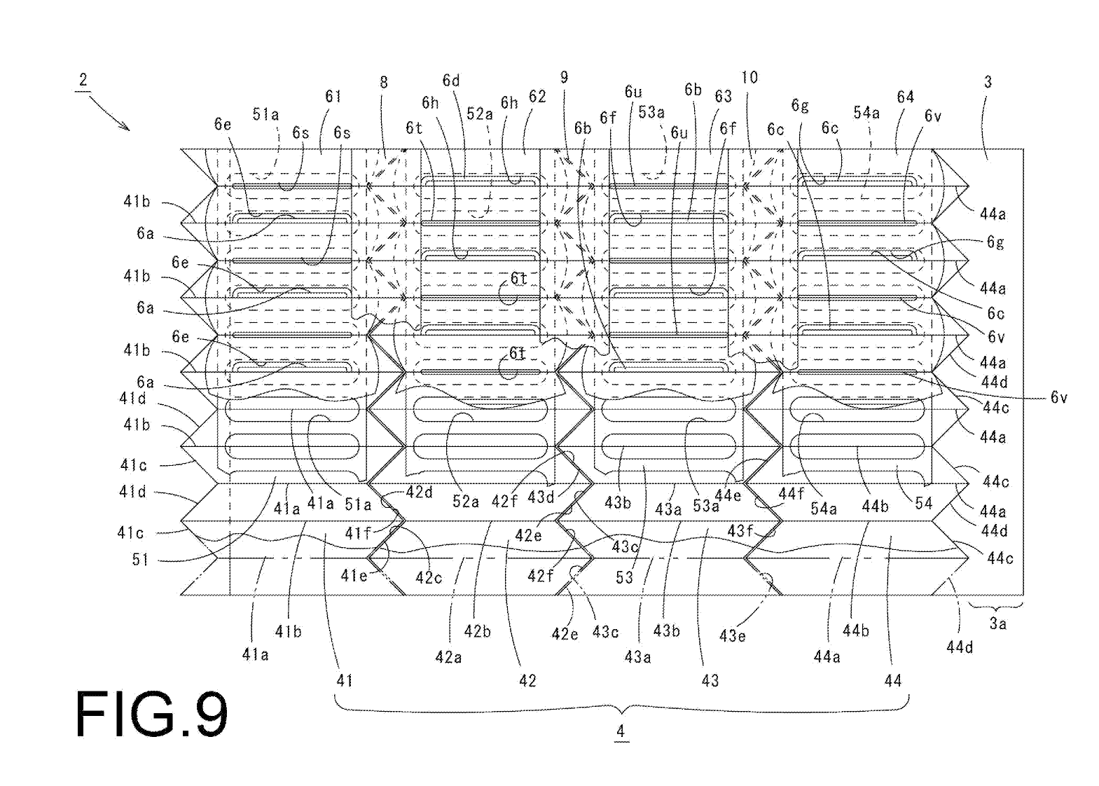

Now the above-mentioned method of manufacturing the beam guiding bellows 1 will be explained step by step. In advance of the explanation, configuration of the first to fourth sheet bodies 3 to 6 will be described. FIG. 9 is plan view, partially broken away, illustrating the bellows-making stacked sheet body 2 configured by stacking the first to fourth sheet bodies 3 to 6, and the above-mentioned first to fourth reinforcing sheet bodies 8, 9 and 10 (the fourth reinforcing sheet body not illustrated). The first sheet body 3 is the outermost cloth of the beam guiding bellows 1, or the outer sheet body configuring the present invention, as described in the above. The first sheet body 3 is composed of a synthetic leather, has a rectangular geometry, and has a margin 3a for gluing on the right side thereof, which is left for gluing for shaping of the folded bellows-making stacked sheet body 2 into a cylinder by overlapping with the first sheet body 3.

What is placed on the first sheet body 3 (on the back surface of the first sheet body 3 in the finished form of the beam guiding bellows 1) is the second sheet body 4, or the intermediate sheet body configuring the present invention. The second sheet body 4 is divided into four parts, in the beam guiding bellows 1 of this embodiment, More specifically, as seen in FIG. 9, the second sheet body 4 is composed of a left interlining 41 disposed leftmost, a lower interlining 42 disposed alongside of the left interlining 41 while keeping a small gap in between, a right interlining 43 disposed alongside of the lower interlining 42 while keeping a small gap in between, and an upper interlining 44 disposed rightmost and alongside of the right interlining 43 while keeping a small gap in between. The left interlining 41 is located in the left portion of the beam guiding bellows 1 illustrated in FIG. 1, the lower interlining 42 is located on the bottom portion of the beam guiding bellows 1, the right interlining 43 is located in the right portion of the beam guiding bellows 1, and the upper interlining 44 is located in the top portion of the beam guiding bellows 1. In the left interlining 41, slits (perforations) 41a are formed side-by-side (in the longitudinal direction of the left interlining 41) corresponding to portions where the left vertical hill sections 2a will be formed as a result of folding. Between the adjacent slits (perforations) 41a, the slits (perforations) 41b are formed corresponding to portions where the left vertical valley sections 2b will be formed. In the lower interlining 42, slits (perforations) 42a are formed side-by-side (in the longitudinal direction of the lower interlining 42) corresponding to portions where the lower transverse valley sections 2h will be formed as a result of folding. Between the adjacent slits (perforations) 42a, slits (perforations) 42b are formed corresponding to portions where the lower transverse hill sections 2g will be formed. In the right interlining 43, slits (perforations) 43a are formed side-by-side (in the longitudinal direction of the right interlining 43) corresponding to portions where the right vertical hill sections 2c will be formed as a result of folding. Between the adjacent slits (perforations) 43a, slits (perforations) 43b are formed corresponding to portions where the right vertical valley sections 2d will be formed. In the upper interlining 44, slits (perforations) 44a are formed side-by-side (in the longitudinal direction of the upper interlining 44) corresponding to portions where the upper transverse valley sections 2f will be formed as a result of folding. Between the adjacent slits (perforations) 44a, slits (perforations) 44b are formed corresponding to portions where the upper transverse hill sections 2e will be formed as a result of folding. On the left edge of the left interlining 41 and on the right edge of the upper interlining 44, there are formed inclined edges 41c, 41d, 44c and 44d which correspond to the one set of left upper slopes 2j and the other set of left upper slopes 2k. On the right edge of the left interlining 41 and on the left edge of the lower interlining 42, there are formed inclined edges 41e, 41f, 42c and 42d which correspond to the one set of left lower slopes 2l and the other set of left lower slopes 2m. On the right edge of the lower interlining 42 and on the left edge of the right interlining 43, there are formed inclined edges 42e, 42f, 43c and 43d which correspond to the one set of right lower slopes 2p and the other set of right lower slopes 2q. On the right edge of the right interlining 43 and on the left edge of the upper interlining 44, there are formed inclined edges 43e, 43f, 44e and 44f which correspond to the one set of right upper slopes 2n and the other set of right upper slopes 2o.

A left adhesive sheet body 51 is adhered to the left interlining 41 (which corresponds to the second sheet body 4), a lower adhesive sheet body 52 is adhered to the lower interlining 42, a right adhesive sheet body 53 is adhered to the right interlining 43, and an upper adhesive sheet body 54 is adhered to the upper interlining 44. The left adhesive sheet body 51, the lower adhesive sheet body 52, the right adhesive sheet body 53, and the upper adhesive sheet body 54 configure the third sheet body 5. In other words, the third sheet body 5 is divided into four parts. The left adhesive sheet body 51, the lower adhesive sheet body 52; the right adhesive sheet body 53, and the upper adhesive sheet body 54 are coated with an adhesive on both surfaces thereof, have lengths equal to those of the left interlining 41, the lower interlining 42, the right interlining 43, and the upper interlining 44, respectively, and have widths equal to the width of the slits (perforations) 41a, 42b, 43a and 44b, respectively. Moreover, each of the left adhesive sheet body 51, the lower adhesive sheet body 52, the right adhesive sheet body 53, and the upper adhesive sheet body 54 has oblong holes 51a, 52a, 53a and 54a respectively formed therein, while being aligned in the longitudinal direction of each sheet body. The oblong holes 51a, 52a, 53a and 54a are formed at positions so as to allow them to be halved at the centers thereof by the slits (perforations) 41a, 41b, 42a, 42b, 43a, 43b, 44a and 44b, with the length thereof slightly shorter than the width of the adhesive sheet bodies 51 and so forth. More specifically, the length of the oblong holes 51a formed in the left adhesive sheet body 51 is slightly shorter than the lengths of the left vertical hill sections 2a and the left vertical valley sections 2b in the final form of the beam guiding bellows 1 after being folded as described later, and the length of the oblong holes 52a formed in the lower adhesive sheet body 52 is slightly shorter than the lengths of the lower transverse hill sections 2g and the lower transverse valley sections 2h in the final form of the beam guiding bellows 1 after being folded as described later. Similarly, the length of the oblong holes 53a formed in the right adhesive sheet body 53 is slightly shorter than the lengths of the right vertical hill sections 2c and the right vertical valley sections 2d in the final form of the beam guiding bellows 1 after being folded as described later, and the length of the oblong holes 54a formed in the upper adhesive sheet body 54 is slightly shorter than the lengths of the upper transverse hill sections 2e and the upper transverse valley sections 2f in the final form of the beam guiding bellows 1 after being folded as described later.

On the left adhesive sheet body 51, the lower adhesive sheet body 52, the right adhesive sheet body 53 and the upper adhesive sheet body 54, there are formed a left protective sheet body 61, a lower protective sheet body 62, a right protective sheet body 63, and an upper protective sheet body 64. The left protective sheet body 61, the lower protective sheet body 62, the right protective sheet body 63, and the upper protective sheet body 64 configure the fourth sheet body 6. In other words, the above-described fourth sheet body 4, which configures the bellows-making stacked sheet body 2 to be formed into the beam guiding bellows 1, is divided into four parts. The above-described plurality of the left slits 6e are formed in the left protective sheet body 61, the plurality of lower slits 6h are formed in the lower protective sheet body 62, the plurality of right slits 6f are formed in the right protective sheet body 63, and the plurality of upper slits 6g are formed in the upper protective sheet body 64. Each of the left slits 6e, the lower slits 6h, the right slits 6f, and the upper slits 6g is a slit formed to have a U-shape as described in the above. Accordingly, in the left adhesive sheet body 51, the lower adhesive sheet body 52, the right adhesive sheet body 53, and in the upper adhesive sheet body 54, the plurality of left protruding flaps 6a, the plurality of lower protruding flaps 6d, the plurality of right protruding flaps 6b, and the plurality of upper protruding flaps 6c are formed by the left slits 6e, the lower slits 6h, the right slits 6f, and the upper slit 6g, respectively. Moreover, in the left protective sheet body 61, the lower protective sheet body 62, the right protective sheet body 63, and in the upper protective sheet body 64, left straight slits 6s are formed between every adjacent left slits 6e, lower straight slits 6t are formed between every adjacent lower slits 6h, right straight slits 6u are formed between every adjacent right slits 6f, and upper straight slits 6v are formed between every adjacent upper slits 6g. All of the left protruding flaps 6a, the lower protruding flaps 6d, the right protruding flaps 6b, the upper protruding flaps 6c, the left straight slits 6s, the lower straight slits 6t, the right straight slits 6u, and the upper straight slits 6v are positioned so as to fall within the oblong holes 51a, 52a, 53a and 54a formed in the left adhesive sheet body 51, the lower adhesive sheet body 52, the right adhesive sheet body 53, and in the upper adhesive sheet body 54, and are thereby set free without being adhered to anything. Both lateral sides of the left protective sheet body 61, the lower protective sheet body 62, the right protective sheet body 63, and the upper protective sheet body 64 have a scallop profile (reference numerals not given) for the convenience of alignment when they are placed on the left adhesive sheet body 51, the lower adhesive sheet body 52, the right adhesive sheet body 53, and the upper adhesive sheet body 54.

On the topmost surface of the bellows-making stacked sheet body 2 (on the innermost surface in the finished form of the beam guiding bellows 1), the first to fourth reinforcing sheet bodies 8, 9 and 10 (the fourth reinforcing sheet body is not illustrated) are adhered (bonded) using an adhesive. All of the first to fourth reinforcing sheet bodies 8, 9, 10 and 11 (the fourth reinforcing sheet body is not illustrated in FIG. 9, since it is bonded after the bellows-making stacked sheet body 2 is folded and shaped into a cylinder by bonding on the margin 3a for gluing. See FIG. 2 to FIG. 4) are ribbon-like component made of a flame-retardant material, and have a length equal to the width of the first sheet body 3. The first reinforcing sheet body 8 is attached to a position which falls between the left slits 6e and the lower straight slits 6t, and between the left straight slits 6s and the lower slits 6h; the second reinforcing sheet body 9 is attached to a position which falls between the lower slits 6h and the right straight slits 6u, and between the lower straight slits 6t and the right slits 6f; the third reinforcing sheet body 10 is attached to a position which falls between the right slits 6f and the upper straight slits 6v, and between the right straight slits 6u and the upper slits 6g. In short, the first to fourth reinforcing sheet body 8, 9, 10 and 11 have a width which falls in the distance between the adjacent slits. The fourth reinforcing sheet body is attached to a position which falls between the oblong holes 54a and 51a. Accordingly, the first to fourth reinforcing sheet bodies 8, 9, 10 and 11 cover the individual corner portions (the one and the other sets of left top corners, the one and the other sets of left bottom corners, the one and the other sets of right bottom corners, and the one and the other sets of right top corners, which configure the present invention); and also cover the one and the other sets of left upper slopes 2j and 2k, the one and the other sets of left lower slopes 2l and 2m, the one and the other sets of right lower slopes 2p and 2q, and the one and the other sets of right upper slopes 2n and 2o.

The thus-configured, bellows-making stacked sheet body 2 is then folded at the positions where the individual slits (perforations) 41a, 41b, 42a, 42b, 43a, 43b, 44a and 44b of the left interlining 41, the lower interlining 42, the right interlining 43, and the upper interlining 44, so as to form the left vertical hill sections 2a, the left vertical valley sections 2b, the right vertical hill sections 2c, the right vertical valley sections 2d, the upper transverse hill sections 2e, the upper transverse valley sections 2f, the lower transverse hill sections 2g, and the lower transverse valley sections 2h, and also so as to form the one set of left upper slopes 2j, the other set of left upper slopes 2k, the one set of left lower slopes 2l, the other set of left lower slopes 2m, the one set of right upper slopes 2n, the other set of right upper slopes 2o, the one set of right lower slopes 2p, and the other set of right lower slopes 2q (folding step). In this process, the individual left protruding flaps 6a, the lower protruding flaps 6d, the right protruding flaps 6b, and the upper protruding flaps 6c automatically rise up in the vicinity of the individual left straight slits 6s, the lower straight slits 6t, the right straight slits 6u, and the upper straight slits 6v, so as to extend from the left vertical valley sections 2b, the right vertical valley sections 2d, the upper transverse valley sections 2f, and the lower transverse valley sections 2h, respectively. After completion of the folding step, the margin 3a for gluing is attached to the exterior of the first sheet body 3 so as to shape the folded bellows-making stacked sheet body 2 into a cylinder, and thereafter the fourth reinforcing sheet body is attached to the interior.

According to the beam guiding bellows 1 manufactured by the method described in the above, even if the fourth sheet body 6 (left protective sheet body 61, lower protective sheet body 62, right protective sheet body 63, upper protective sheet body 64) which composes the inner sheet body is irradiated by scattered or reversed laser light, the beam guiding bellows 1 may successfully avoid the risk of being burnt or damaged, through absorption or reflection of the laser light. In addition, in the beam guiding bellows 1, the laser light incident on any of the left protruding flaps 6a, the lower protruding flaps 6d, the right protruding flaps 6b, and the upper protruding flaps 6c, which are formed as the protruding flaps configuring the present invention using the fourth sheet body 6 (left protective sheet body 61, lower protective sheet body 62, right protective sheet body 63, upper protective sheet body 64), will no longer irradiate the fourth sheet body 6 including the protruding flaps which fall behind (in the direction opposite to the oscillator than) the irradiated protruding flaps. Accordingly, by virtue of the inwardly projected arrangement of the protruding flaps 6a and so forth inside the beam guiding bellows, the risk of burning or other damages is more effectively avoidable.

In addition, the left protruding flaps 6a, the lower protruding flaps 6d, the right protruding flaps 6b, and the upper protruding flaps 6c which configure the protruding flaps are formed (projected) automatically in the process folding the inner sheet body 2 as described in the above, so that the bellows may be manufactured within a very short time at low costs, and may further ensure reduction in the number of components and reduction in weight as a consequence.

In particular, in the beam guiding bellows 1 of the above-described embodiment, since the left straight slits 6s, the lower straight slits 6t, the right straight slits 6u, and the upper straight slits 6v are respectively formed in the left protective sheet body 61, the lower protective sheet body 62, the right protective sheet body 63, and in the upper protective sheet body 64, in the portions corresponded to the left vertical hill sections 2a, the right vertical hill sections 2c, the upper transverse hill sections 2e, and the lower transverse hill sections 2g, so that the protective sheet bodies 61 and so forth may be prevented from being released due to rupture or separation possibly caused by repetitive expansion and retraction of the beam guiding bellows 1. Since the individual corner portions (the one and the other sets of left top corners, the one and the other sets of left bottom corners, the one and the other sets of right bottom corners, and the one and the other sets of right top corners configuring the present invention), and also the one and the other sets of left upper slopes 2j and 2k, the one and the other sets of left lower slopes 2l and 2m, the one and the other sets of right lower slopes 2p and 2q, and the one and the other sets of right upper slopes 2n and 2o are covered with the first to fourth reinforcing sheet bodies 8, 9, 10 and 11 so that the protective sheet bodies 61 and so forth may more effectively be prevented from being released due to rupture or separation possibly caused by repetitive folding.

While the exemplary case described in the above, referring to the attached drawings in relation to the embodiment of the beam guiding bellows 1, was such that the third sheet body 6, or the inner sheet body configuring the present invention, was divided into four parts which include the left protective sheet body 61, the lower protective sheet body 62, the right protective sheet body 63, and the upper protective sheet body 64, the inner sheet body may alternatively be configured by a single sheet body. Also while the beam guiding bellows 1 of this embodiment described in the above had the one set of left upper slopes 2j, the other set of left upper slopes 2k, the one set of left lower slopes 2l, the other set of left lower slopes 2m, the one set of right upper slopes 2n, the other set of right upper slopes 2o, the one set of right lower slopes 2p, and the other set of right lower slopes 2q formed therein, the beam guiding bellows 1 of the present invention may alternatively have none of these slopes formed therein.

1. A beam guiding bellows for laser cutting machine which is disposed along an optical path of a laser cutting machine for irradiating laser light emitted from an oscillator,
the beam guiding bellows being configured by a plurality of stacked sheet bodies, including an inner sheet body disposed innermostly, integrally folded so as to alternately form hill sections and valley sections, and thereby being made freely expandable and retractable in the overall length as angles of the hill sections and valley sections vary,
the inner sheet body being composed of a material capable of protecting the inner sheet body by absorbing or reflecting the laser light having been scattered or reversed, or having, formed on the inner surface thereof, a protective layer composed of a material capable of protecting the inner sheet body by absorbing or reflecting the laser light, and
the inner sheet body having protruding flaps which are formed, automatically in the process of folding it together with the other sheet bodies to thereby form the hill sections and the valley sections alternately, so as to project further inwardly from the apexes of the valley sections.

2. The beam guiding bellows for laser cutting machine according to claim 1,
wherein the hill sections and the valley sections are composed of vertical hill sections and vertical valley sections formed on both lateral sides, and transverse hill sections and transverse valley sections formed on the top and bottom sides, and every one of, or every other one of, the vertical valley sections and the transverse valley sections have the protruding flaps, formed thereon.

3. The beam guiding bellows for laser cutting machine according to claim 1 or 2,
wherein the inner sheet body has straight slits formed in portions corresponded to the apexes of the hill sections, or apexes of the vertical hill sections and the transverse hill sections, the straight slits being shorter than the overall length of the hill sections, or the overall length of the vertical hill sections and the transverse hill sections.

4. The beam guiding bellows for laser cutting machine according to claim 2,
wherein the individual vertical hill sections formed on the left side and the individual transverse valley sections formed on the top side are respectively joined at one set of left top corners, the individual vertical valley sections formed on the left side and the individual transverse hill sections formed on the top side are respectively joint at the other set of left top corners, the individual vertical hill sections formed on the right side and the individual transverse valley sections formed on the top side are respectively joined at one set of right top corners, the individual vertical valley sections formed on the right side and the individual transverse hill sections formed on the top side are respectively joined at the other set of right top corners, the individual vertical hill sections formed on the left side and the individual transverse valley sections formed on the bottom side are respectively joined at one set of left bottom corners, the individual vertical valley sections formed on the left side and the individual transverse hill sections formed on the bottom side are respectively joined at the other set of left bottom corners, the individual vertical hill sections formed on the right side and the individual transverse valley sections formed on the bottom side are respectively joined at one set of right bottom corners, the individual vertical valley sections formed on the right side and the individual transverse hill sections formed on the bottom side are respectively joined at the other set of right bottom corners, the inner sheet body has first to fourth reinforcing sheet bodies, each of which having the longitudinal direction thereof aligned in the direction of expansion, attached to the inner surface thereof, the first reinforcing sheet body covering the one and the other sets of left top corners, the second reinforcing sheet body covering the one and the other sets of right top corners, the third reinforcing sheet body covering the one and the other sets of left bottom corners, and the fourth reinforcing sheet body covering the one and the other sets of right bottom corners.

5. The beam guiding bellows for laser cutting machine according to claim 4,
wherein the inner sheet body has U-shaped slits preliminarily formed therein before being folded to form the valley sections, the outer contour of each protruding flap corresponds to the geometry of the U-shaped slit, and each of the first to fourth reinforcing sheet bodies has a width ranging from the end of the straight slit to the end of the U-shaped slit.

6. A method of manufacturing a beam guiding bellows for laser cutting machine, comprising:
producing a bellows-making stacked sheet body by stacking an outer sheet body and an intermediate sheet body and the inner sheet body so as to integrate them; and
folding the bellows-making stacked sheet body so as to alternately form hill sections and valley sections,
the inner sheet body having formed therein U-shaped slits which are configured to automatically form, when folded to form valley sections therealong, protruding flaps so as to project them out from the apexes of the valley sections.

7. The method of manufacturing a beam guiding bellows for laser cutting machine according to claim 6,
wherein the inner sheet body has formed therein straight slits arranged in the longitudinal direction of the U-shaped slits, while keeping a predetermined distance in between, and
the bellows-making stacked sheet body is folded so as to form the valley sections along the U-shaped slits and to form the hill sections along the straight slits.
